(19) United States
(12) Patent Application Publication
(10) Pub. No.: US 2013/0221112 A1
(43) Pub. Date: Aug. 29, 2013

(54) ELECTRONIC CARD

(71) Applicant: SIPIX TECHNOLOGY INC., (US)

(72) Inventors: Ching-Hong Lai, New Taipei City (TW); Ming-Jong Jou, Hsinchu City (TW); Chi-Mao Hung, Hsinchu City (TW); Yao-Jen Hsieh, Hsinchu County (TW)

(73) Assignee: SIPIX TECHNOLOGY INC., Taoyuan County (TW)

(21) Appl. No.: 13/740,285

(22) Filed: Jan. 14, 2013

(30) Foreign Application Priority Data
Feb. 24, 2012 (TW) 101106336

(51) Int. Cl. G06K 19/077

(52) U.S. Cl. CPC G06K 19/07707
USPC 235/492

(57) ABSTRACT

An electronic card including a function indication area and a content display area is provided. The function indication area indicates an operational function of the electronic card. The content display area displays the content corresponding to the operational function. Accordingly, the user can comprehend the operational function of the electronic card through the function indication area.

### CROSS-REFERENCE TO RELATED APPLICATION

This application claims the priority benefit of Taiwan application serial no. 101106336, filed on Feb. 24, 2012. The entirety of the above-mentioned patent application is hereby incorporated by reference herein and made a part of this specification.

### BACKGROUND OF THE INVENTION

1. Technical Field

The invention relates generally to an electronic card, and more particularly to an electronic card having a display panel.

2. Related Art

Currently, electronic cards (e.g., credit cards, access cards, and easy cards) are being widely adopted, making them indispensable electronic products for the modern people. Moreover, as semiconductor technologies advance, the circuit complexities of a single chip has increased such that each chip has more and more integrated functions, and the chip area is trending towards compactness. Due to the multi-functionality of the single chip, the operational functions provided by the electronic card are also becoming diverse. Moreover, by configuring a display panel on the electronic card, a user interface is provided through the display panel. However, without knowing the operational functions of the electronic card, a user cannot comprehend the information provided by the display panel, thus affecting the usage convenience of the electronic card.

### SUMMARY OF THE INVENTION

The invention provides an electronic card capable of indication according to the operational function of the electronic card.

The invention provides an electronic card, including a function indication area and a content display area. The function indication area indicates an operational function of the electronic card. The content display area displays a content corresponding to the operational function.

According to an embodiment of the invention, the function indication area includes a first display section of a display panel, and the content display area includes a second display section of the display panel, in which the first display section is different from the section display section.

In summary, in the electronic card according to embodiments of the invention, the operational function of the electronic card is indicated through the function indication area. Moreover, the information content corresponding to the operational function is displayed by the content display area of the electronic card. Accordingly, the user can rapidly comprehend the displayed information of the electronic card, thereby enhancing the usage convenience of the electronic card.

Several exemplary embodiments accompanied with figures are described in detail below to further describe the disclosure in details.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic view of an electronic card according to an embodiment of the invention.

FIG. 1B is a systemic schematic view of the electronic card depicted in FIG. 1A according to an embodiment of the invention.

FIG. 2A is a schematic view of an electronic card according to another embodiment of the invention.

FIG. 2B is a systemic schematic view of the electronic card depicted in FIG. 2A according to an embodiment of the invention.

### DESCRIPTION OF EMBODIMENTS

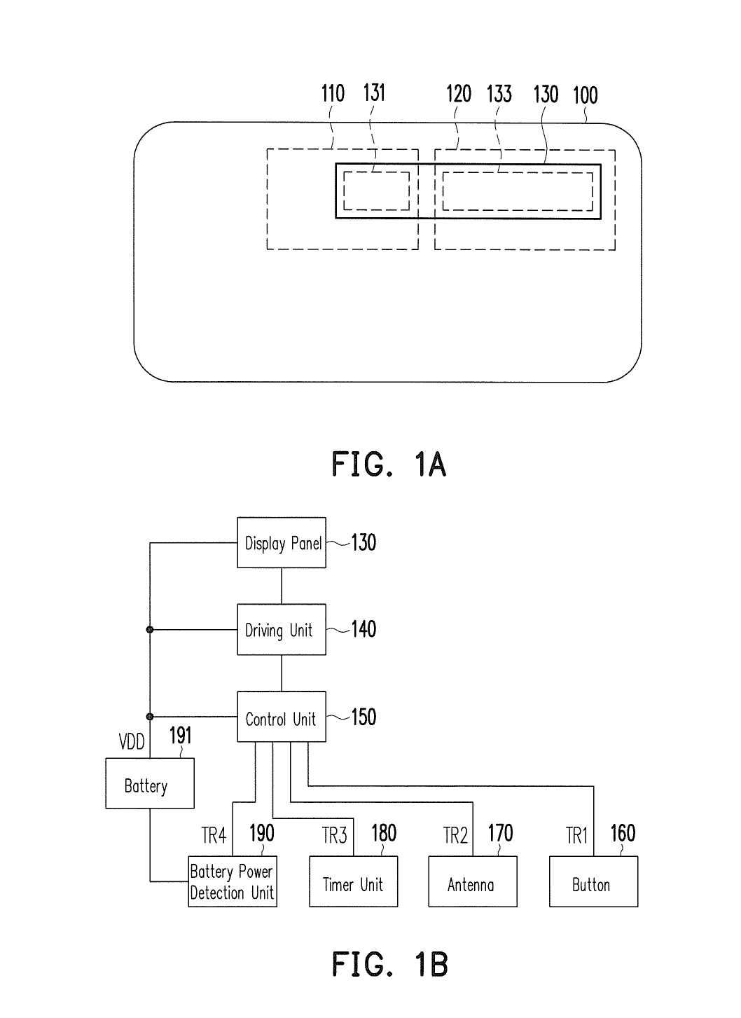

FIG. 1A is a schematic view of an electronic card according to an embodiment of the invention. Referring to FIG. 1A, in the present embodiment, an electronic card 100 includes a function indication area 110 and a content display area 120, and is configured with a display panel 130 divided into a first display section 131 and a second display section 133. Assume here in the disclosure that the first display section 131 of the display panel 130 is disposed in the function indication area 110. That is to say, the function indication area 110 includes the first display section 131. Moreover, assume that the second display section 133 of the display panel 130 is disposed in the content display area 120. In other words, the content display area 120 includes the second display section 133.

In the present embodiment, the first display section 131 in the function indication area 110 indicates an operational function of the electronic card 100. The second display section 133 in the content display area 120 displays a content corresponding to the operational function. For example, when the electronic card 100 has an electronic wallet function, the user may be notified of a remaining balance displayed on the second display section 133 through the indication on the first display section 131. In the present embodiment, the first display section 131 and the second display section 133 of the display panel 130 are configured from left to right. However, in other embodiments, the first display section 131 and the second display section 133 of the display panel 130 may be configured up and down, or the first display section 131 can be configured at a corner of the display panel 130, and the second display section 133 is disposed on the rest of the display panel 130, so that the configuration is in accordance with a design requirement, and the embodiments of the invention are not limited thereto.

In the present embodiment, the operational function currently performed by the electronic card 100 may be represented through the patterns or text displayed by the first display section 131 of the function indication area 110. For example, when the operational function currently performed by the electronic card 100 is the electronic wallet function, the first display section 131 may display symbols (e.g., “+” or “$”), letters (e.g. “c”), or word strings (e.g., “NT” or “cash”) to indicate the operational function currently performed by the electronic card 100. Moreover, the operational function currently performed by the electronic card 100 may be represented through a variation of a display state of the first display section 131 in the function indication area 110, in which the display state includes a light emitting frequency, brightness, and color, for example. In other words, the first display section 131 may have a specific flicker frequency (i.e. the light emitting frequency), a specific light emitting brightness, or a specific light emitting color to indicate the operational function currently performed by the electronic card 100.

In other embodiments of the invention, a part or all of the display states of the first display section 131 may be combined, so that the function indication area 110 indicates the operational function of the electronic card 100. For example, the first display section 131 may display specific light emitting color, flicker frequency, and display specific word strings to indicate the operational function currently performed by the electronic card 100.

FIG. 1B is a systemic schematic view of the electronic card depicted in FIG. 1A according to an embodiment of the invention. Referring to FIGS. 1A and 1B, in the present embodiment, the electronic card 100 further includes a driving unit 140, a control unit 150, a button 160, an antenna 170, a timer unit 180, a battery power detection unit 190, and a battery 191. The driving unit 140 is electrically connected to the display panel 130 to drive the display panel 130. That is to say, the first display section 131 and the second display section 133 of the display panel 130 are driven according to the operational function of the electronic card 100 and the corresponding display content. The control unit 150 is electrically connected to the driving unit 140 to switch the operational function of the electronic card 100 according to a trigger signal (e.g. TR1-TR4), and to control the driving unit 140 according to the operational function of the electronic card 100, so as to correspondingly adjust the content displayed by the first display section 131 (e.g. indicating the operational function of the electronic card 100) and the content displayed by the second display section 133 (e.g. corresponding to the content of the operational function of the electronic card 100).

The button 160 is electrically connected to the control unit 150 to generate a trigger signal TR1. The antenna 170 is electrically connected to the control unit 150 to sense a trigger signal TR2 external to the electronic card 100, such as a trigger signal TR2 transmitted by a card reader. Moreover, the antenna 170 transmits the trigger signal TR2 to the control unit 150. The timer unit 180 is electrically connected to the control unit 150. Every time a timing of the timer unit 180 reaches a predetermined period, the timer unit 180 generates a trigger signal TR3 and transmits it to the control unit 150. The battery 191 is electrically connected to the display panel 130, the driving unit 140, the control unit 150, and the battery power detection unit 190 to provide a working voltage VDD to the display panel 130, the driving unit 140, the control unit 150, and the battery power detection unit 190. The battery power detection unit 190 is electrically connected to the control unit 150. When the battery power detection unit 190 detects a power level of the battery 191 is lower than a predetermined level, the battery power detection unit 190 generates a trigger signal TR4 and transmits it to the control unit 150.

In more specifics, when the button 160 is being pressed, the button 160 emits and transmits the trigger signal TR1 to the control unit 150. The control unit 150 switches the operational function of the electronic card 100 according to the trigger signal TR1, and simultaneously controls the driving unit 140 to drive the display panel 130 so the first display section 131 indicates the operational function of the electronic card 100, and the second display section 133 displays the content corresponding to the operational function. When the antenna 170 senses the trigger signal TR2 external to the electronic card 100, the antenna 170 transmits the sensed trigger signal TR2 to the control unit 150. The control unit 150 switches the operational function of the electronic card 100 according to the trigger signal TR2, and simultaneously controls the driving unit 140 to drive the display panel 130 so the first display section 131 indicates the operational function of the electronic card 100, and the second display section 133 displays the content corresponding to the operational function.

Every time the timing of the timer unit 180 reaches the predetermined period, the timer unit 180 generates the trigger signal TR3. The control unit 150 switches the operational function of the electronic card 100 according to the trigger signal TR3, and simultaneously controls the driving unit 140 to drive the display panel 130 so the first display section 131 indicates the operational function of the electronic card 100, and the second display section 133 displays the content corresponding to the operational function. The timer unit 180 may include circuitry having a timing function, such as a real time clock (RTC) circuit to determine whether the timing has reaches the predetermined period according to a timing result, for example. When the battery power detection unit 190 detects the power level of the battery 191 is lower than the predetermined level (e.g. battery capacity at 20%), the battery power detection unit 190 generates the trigger signal TR4. The control unit 150 switches the operational function of the electronic card 100 according to the trigger signal TR4, and simultaneously controls the driving unit 140 to drive the display panel 130 so the first display section 131 indicates the operational function of the electronic card 100, and the second display section 133 displays the content corresponding to the operational function.

In the present embodiment, the control unit 150 respectively switches the operational function of the electronic card 100 according to the trigger signals TR1-TR4, and controls the driving unit 140 to drive the display panel 130 so as to correspondingly adjust the display content. Since the conditions for generating the trigger signals TR2-TR4 are different, the operational functions corresponding to the trigger signals TR2-TR4 may be different. For example, the operational function corresponding to the trigger signal TR2 may be to display a credit card purchase amount, the operational function corresponding to the trigger signal TR3 may be to display a periodic information (e.g. time), and the operational function corresponding to the trigger signal TR4 may be to display the battery capacity. Furthermore, the operational function corresponding to the trigger signal TR1 generated by the button 160 may include the operational functions corresponding to the trigger signals TR2-TR4, which may be configured by one skilled in the art, and embodiments of the invention are not limited thereto.

In one embodiment of the invention, the button 160 may be a single button, or a combination of a plurality of buttons. The trigger signal TR1 may be generated in response to a press of a corresponding specific button, or may be generated in response to a press of a corresponding combination of specific buttons, according to a circuit design requirement. Moreover, the control unit 150 may switch the operational function of the electronic card 100 according to a combination of the trigger signals TR1-TR4, and control the driving unit 140 to drive the display panel 130 to correspondingly adjust the display content. For example, a combination of the trigger signals TR1 and TR2 corresponds to an operational function, and a combination of the trigger signals TR1 and TR3 corresponds to another operational function.

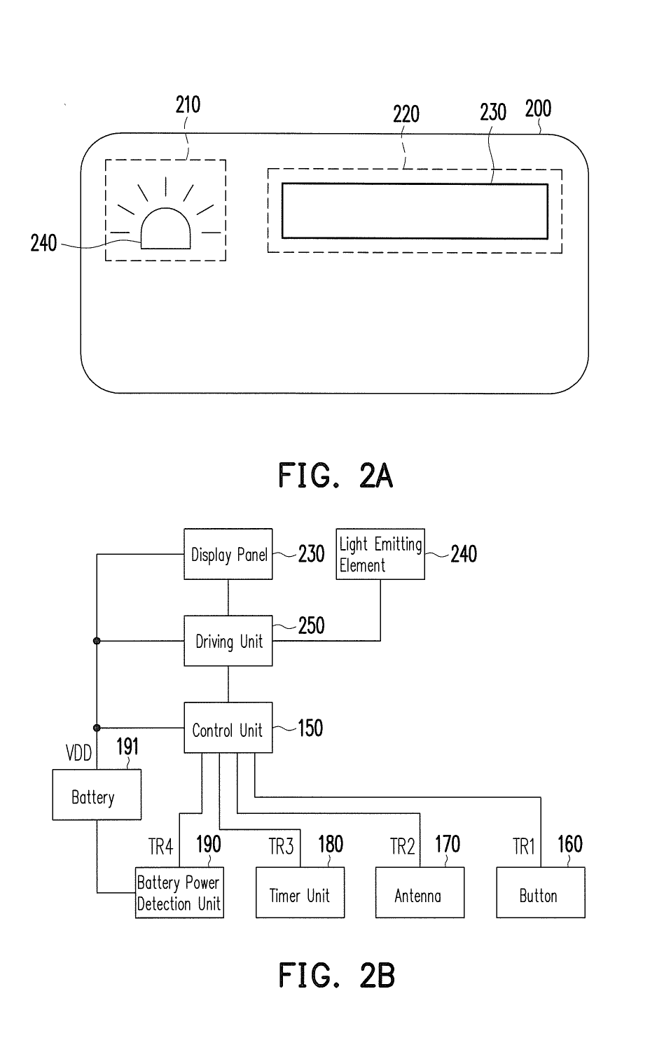

FIG. 2A is a schematic view of an electronic card according to another embodiment of the invention. Referring to FIG. 2A, in the present embodiment, an electronic card 200 includes a function indication area 210 and a content display area 220, and is configured with a display panel 230 and a light emitting element 240. In the disclosure, assume the light emitting element 240 is disposed in the function indication area 210. That is to say, the function indication area 210 includes the light emitting element 240. Moreover, assume that the display panel 230 is disposed in the content display area 220. In other words, the content display area 220 includes the display panel 230.

In the present embodiment, the light emitting element 240 in the function indication area 210 indicates an operational function of the electronic card 200. The display panel 230 in the content display area 220 displays a content corresponding to the operational function. In the present embodiment, the light emitting element 240 is disposed on a left side of the display panel 230. However, in other embodiments, the light emitting element 240 may be disposed on a top side, bottom side, or right side of the display panel 230. Alternatively, the light emitting element 240 may be disposed at an observable area on the electronic card 200 according to a design requirement, and embodiments of the invention are not limited thereto. In the present embodiment, the operational function currently performed by the electronic card 200 may be represented through a light emitting state of the light emitting element 240 in the function indication area 210, in which the light emitting state includes a light emitting frequency, brightness, and color, for example. In other words, the light emitting element 240 may have a specific flicker frequency (i.e. the light emitting frequency), a specific light emitting brightness, or a specific light emitting color to indicate the operational function currently performed by the electronic card 200.

In other embodiments of the invention, a part or all of the light emitting states of the light emitting element 240 may be combined, or a plurality of light emitting elements 240 may be provided on the electronic card 200, such that the light emitting states of the plurality of light emitting elements 240 may be combined so that the function indication area 210 indicates the operational function of the electronic card 200. For example, the light emitting element 240 may emit a specific light emitting color, brightness, and/or flicker frequency to indicate the operational function currently performed by the electronic card 200. Alternatively, the plurality of light emitting elements 240 may emit a combination of specific light emitting colors, brightness, and/or flicker frequencies to indicate the operational function currently performed.

FIG. 2B is a systemic schematic view of the electronic card depicted in FIG. 2A according to an embodiment of the invention. Referring to FIGS. 1B and 2B, the structure of the electronic card 200 is largely similar to the electronic card 100, and differences between the two lie in the display panel 230, the light emitting element 240, and a driving unit 250. Similar or the same reference labels represent similar or the same elements. In the present embodiment, the driving unit 250 is controlled by the control unit 150 to drive the light emitting element 240, so as to indicate the operational function of the electronic card 200. Moreover, the driving unit 250 is controlled by the control unit 150 to drive the display panel 230 in order to display a content corresponding to the operational function of the electronic card 200. Accordingly, the driving unit 250 of the electronic card 200 is electrically connected to the light emitting element 240, and the control unit 150 controls the driving unit 250 to correspondingly adjust the light emitting states of the light emitting element according to the trigger signals TR1-TR4.

In view of the foregoing, according to embodiments of the invention, the electronic card includes the function indication area and the content display area. The electronic card indicates the operational function of the electronic card through the display panel or the light emitting element of the function indication area. Moreover, the content corresponding to the operational function is displayed by the display panel of the content display area. Accordingly, the user can rapidly comprehend the displayed information of the electronic card, thereby enhancing the usage convenience of the electronic card.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. An electronic card, comprising:
a function indication area indicating an operational function of the electronic card; and
a content display area displaying a content corresponding to the operational function.

2. The electronic card as claimed in claim 1, wherein the function indication area comprises a first display section of a display panel, the content display area comprises a second display section of the display panel, wherein the first display section is different from the section display section.

3. The electronic card as claimed in claim 2, further comprising:
a driving unit electrically connected to the display panel to drive the display panel; and
a control unit electrically connected to the driving unit, the control unit switching the operational function of the electronic card according to a trigger signal, and accordingly controlling the driving unit so as to correspondingly adjust the operational function and a corresponding content displayed by the display panel.

4. The electronic card as claimed in claim 3, further comprising a button electrically connected to the control unit to generate the trigger signal.

5. The electronic card as claimed in claim 3, further comprising an antenna electrically connected to the control unit to sense the trigger signal external to the electronic card.

6. The electronic card as claimed in claim 3, further comprising a timer unit electrically connected to the control unit, the timer unit generating the trigger signal every time a timing of the timer unit reaches a predetermined period.

7. The electronic card as claimed in claim 3, further comprising a battery and a battery power detection unit, the battery electrically connected to the display panel, the driving unit, the control unit, and the battery power detection unit, the battery power detection unit electrically connected to the control unit, and the battery power detection unit generating the trigger signal when the battery power detection unit detects a power level of the battery is lower than a predetermined level.

8. The electronic card as claimed in claim 2, wherein the first display section indicates the operational function through displaying at least one of a light emitting frequency, a light emitting brightness, a light emitting color, a symbol, a letter, and a word string.

9. The electronic card as claimed in claim 1, wherein the function indication area comprises a light emitting element, the content display area comprises a display panel, and the light emitting element indicates the operational function through a light emitting state thereof.

10. The electronic card as claimed in claim 9, further comprising:
a driving unit electrically connected to the light emitting element and the display panel to drive the light emitting element and the display panel; and
a control unit electrically connected to the driving unit, the control unit switching the operational function of the electronic card according to a trigger signal, and accordingly controlling the driving unit so as to correspondingly adjust the light emitting state of the light emitting element, and to correspondingly adjust a display content of the display panel.

11. The electronic card as claimed in claim 10, further comprising a button electrically connected to the control unit to generate the trigger signal.

12. The electronic card as claimed in claim 10, further comprising an antenna electrically connected to the control unit to sense the trigger signal external to the electronic card.

13. The electronic card as claimed in claim 10, further comprising a timer unit electrically connected to the control unit, the timer unit generating the trigger signal every time a timing of the timer unit reaches a predetermined period.

14. The electronic card as claimed in claim 10, further comprising a battery and a battery power detection unit, the battery electrically connected to the display panel, the driving unit, the control unit, and the battery power detection unit, the battery power detection unit electrically connected to the control unit, and the battery power detection unit generating the trigger signal when the battery power detection unit detects a power level of the battery is lower than a predetermined level.

15. The electronic card as claimed in claim 9, wherein the light emitting state of the light emitting element comprises at least one of a light emitting frequency, a light emitting brightness, and a light emitting color.
